(19) United States
(12) Patent Application Publication
(10) Pub. No.: US 2008/0221915 A1
(43) Pub. Date: Sep. 11, 2008

(54) Softwate method and system to enable compliance with audit requirements for electronic procurement pricing

(76) Inventors: Gary Charles Berkowitz, Centennial, CO (US); Charles Christopher Wurtz, (US)

Correspondence Address: Gary C. Berkowitz, 7778 S. Poplar Way, Centennial, CO, 80112, US

(21) Appl. No.: 12/074,798

(22) Filed: Mar. 5, 2008

Related U.S. Application Data
(60) Provisional application No. 60/905,059, filed on Mar. 5, 2007.

(51) Int. Cl. G06Q 99/00

(52) U.S. Cl. 705/1

(57) ABSTRACT

The present invention, named PriceAudit, is an electronic procurement tool that enables the buyer, or purchasing organization, to precisely audit, and therefore validate, on a near real-time basis, their purchasing patterns and prices across all of their (or any other) internet-based suppliers. It allows the comparison of punchout (live supplier internet catalog) price information with prior or negotiated prices, offering the ability to audit and analyze price changes. This enables the user to compare and track price changes from punchout suppliers, compile information for Sarbanes-Oxley reporting requirements, and ensure compliance with supplier contracts, via comparison of prices paid with prices negotiated with a supplier.

### BACKGROUND OF THE INVENTION

1. Field of the Invention

The present invention is directed toward the field of electronic procurement systems. More specifically, the technology described in this provisional patent application relates to a system and method to enable an electronic procurement buyer to comply with both internal audit and government reporting requirements regarding pricing.

2. Description of the Related Art

A pending utility patent application (Knowledge-based e-catalog procurement system and method, U.S. Ser. No. 10/215,109) provides a solution to one of the fundamental problems of B2B Internet commerce, which is the ability to electronically shop a heterogeneous mix of vendors, or suppliers, whose catalog contents appear in a variety of formats, and further, the ability of an organization to capture and store the shopping patterns and choices of its buyers (shoppers), and to make this evolving knowledge available to the entire organization.

The present invention, termed IntelleCat Price Audit (or simply PriceAudit) in its preferred embodiment, augments this approach with a tool that enables the buyer, or purchasing organization, to precisely audit, and therefore validate, on a near real-time basis, their purchasing patterns and prices across all of their (or any other) internet-based suppliers.

There are no known current technologies that provide this functionality.

### BRIEF SUMMARY OF THE INVENTION

The present invention, named PriceAudit, is an electronic procurement tool that enables the buyer, or purchasing organization, to precisely audit, and therefore validate, on a near real-time basis, their purchasing patterns and prices across all of their (or any other) internet-based suppliers. It allows the comparison of punchout (live supplier internet catalog) price information, offering the ability to audit and analyze price changes. This enables the user to:
Compare and track price changes from punchout suppliers,
Compile information for Sarbanes-Oxley reporting requirements, and
Ensure compliance with supplier contracts, via comparison of prices paid with prices negotiated with a supplier.
   PriceAudit provides the buying and supplying organizations full reassurance that their negotiated prices and their contractual agreements can be fully reported to all involved parties. This includes governmental regulators, shareholders, and external auditors.

PriceAudit also helps ensure that the buyer or purchasing organization can immediately detect fraud and mismanagement of the internet-catalog supply chain.

### BRIEF DESCRIPTION OF THE DRAWINGS

FIG. 1 is a representation of the Price Audit Punch-Out screen.

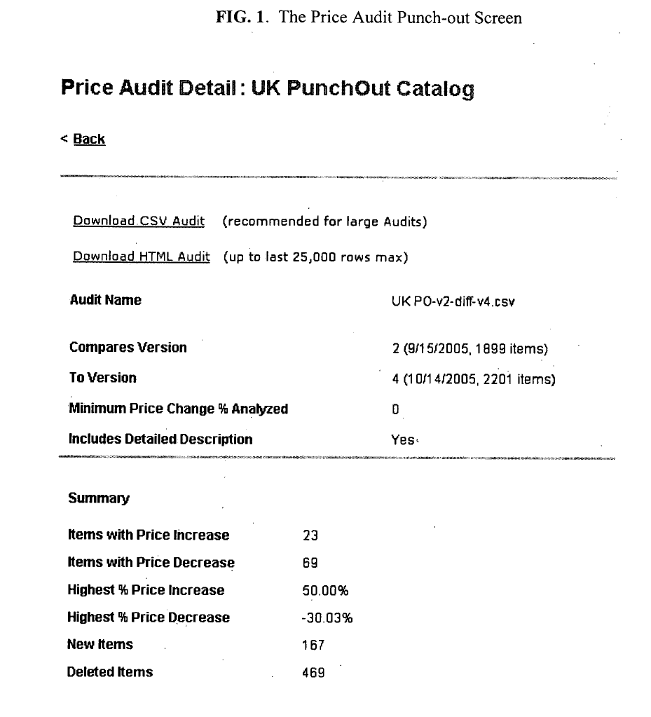

### DETAILED DESCRIPTION OF THE INVENTION

The detailed description of the present invention also incorporates by reference, in whole, the computer program listing appendix submitted with this application on CD-R discs, as referenced at the beginning of the Specification.

This guide describes catalog administration functionality for the IntelleCat™ Content Administrator area.

### Key Concepts

This section explains some key terms and concepts used by IntelleCat. In order to make content available for search and purchase through IntelleCat, Content Administrators typically perform the following steps:

1) Create supplier.

2) Create one or more catalogs for a given supplier.

3) Upload Content Source for a given supplier.

4) Create one or more versions with the uploaded content source as base data for a given catalog.

5) Approve catalog versions.

6) Activate one version for a given catalog.

7) Set Search Access to On for a given catalog.

### Web Enhancement Overview

Most eProcurement catalogs are based on a base data file (also referred to as content source) that contains part or all of the item content of a Supplier to a given Buyer. IntelleCat supports the ability of supplementing data from the basic data file (content source) with additional information from the Internet as made available by the Supplier. This unique IntelleCat patent-pending process of enriching catalog content in this manner is called ‘Web Enhancement’.

IntelleCat supports enhancing static catalogs as well as dynamic web (punchout) catalogs. Static catalogs can be web enhanced when a supplier has for example a web site with additional item information and provides item-specific URLs for some or all of their items in the base data file provided to the Buyer. Many suppliers maintain web sites that have item-specific pages with more information about individual items than is available in the static catalog. By combining item data from the catalog with item data from a web site, the IntelleCat index and product descriptions are much richer than could be created from file data alone. Such enriched catalogs makes searching and finding items for end users much faster and easier than non-web-enhanced catalogs.

For more information on web-enhancement of static catalogs see the New Versions section of this document.

IntelleCat also supports the web enhancement of web (punchout) catalogs. Web catalog enhancement means that IntelleCat explores the web site and provides an item-level search capability, “Direct SKU Punchout” through IntelleCat. This vastly improves the ability of Users to find target items while eliminating the need for shoppers to learn the search mechanisms and capabilities of each individual punchout site.

### IntelleCat Administrator Navigation Bar

The IntelleCat Administrator Navigation bar provides links for access to most IntelleCat Content Administrator actions and their screens. The following actions are available:
Content Overview
Create New Catalog
Upload Content
Catalog Summary
View Site Visibility
Create New Supplier
View list of Suppliers
Create New Administrator User
View list of Administrator Users
Logout (of IntelleCat Content Administration)

### Content Overview

After logging into IntelleCat as Content Administrator this will bring up the Content Overview Screen.
Note: The user must have the necessary permissions in order to access the catalog administration and maintenance section of IntelleCat.
An overview of all supplier catalogs, which are authorized for specific login ids, is displayed.
On this screen Content Administrators can:
View the List of Catalogs
Create New Catalogs
Delete Checked Catalogs
Upload Data Source
View Details of a Catalog
   These actions are described in more detail in the following sections.

### List of Catalogs

In addition to the above actions, the Content Overview screen contains a summary of catalog information. The catalog data display contains the following information:

### Catalog Name

Name of catalog.
Clicking on the Catalog Name takes the User to the Catalog Summary screen for the chosen catalog, which provides specific catalog and catalog version information and functionality. Please see sections below for more information.
Note: The items in a catalog must be from one Supplier.

### Supplier

Name of supplier to catalog.

### Search Access

Search Access for a catalog can be either On or Off.

### Site Visibility

Sites (Buying Groups) for which a catalog has been made visible.

### Supplier Catalog Preference

Preference level of a catalog to be used for ranking of Search Results in end users view.

### Catalog Type

Displays the type of catalog: CIF, CSV, Internet Punchout (web), IntelleSpotBuy™.

### Index Date of Last Version

The creation date of the most recent catalog version is.

### Index Status of Last Version

Displays the status of the most recent catalog version as Ready/Incomplete/Loading.
See Section Create/Loading for further information on possible load status.

### Approval Status of Last Version

Displays the approval status of the most recent catalog version as Approved/Pending/Rejected.
   From this screen a correctly permissioned IntelleCat Administrator User can also perform the following actions:
Delete Checked Catalogs
This function allows the User to delete existing catalogs from IntelleCat, by clicking on the checkboxes for the desired catalog(s) and then clicking on the Delete Checked Catalogs link.
All versions of a catalog will be deleted when the catalog is deleted from the system. If the Content Administrator User deletes a catalog while it might be in use by end users, end users will lose access to the catalog.

Confirm Delete Catalog Screen:
The Confirm Delete Catalog screen provides the Content Administrator with a way to confirm deletion of an entire catalog, including all versions for the catalog. This screen is reached by selecting Delete Checked Catalogs from the Content Overview screen.

### Create New Catalog Screen.

This action allows the Administrator User to create a new catalog.

### Create New Catalog Screen

To load a new supplier's content an Administrator User first creates a catalog (before adding items to a catalog). The following information is required for a catalog:
   Catalog Name: Enter a name for the catalog.
Select Supplier: Select a supplier for this catalog. Select from a list of existing suppliers within the IntelleCat system.
Select Catalog Type: Select from: CIF, CSV, Internet Punchout, and IntelleSpotBuy.
   Once valid values for the fields have been completed, click on Create Catalog to return to the Content Overview screen.
   On the Content Overview screen, this action allows a Content Administrator to delete existing catalog(s). All versions of the catalog will be deleted when the catalog is deleted from the system. If the Content Administrator User deletes a catalog while it might be in use by end users, end users will lose access to the catalog.

### Confirm Delete Catalog Screen

The Confirm Delete Catalog screen provides the Content Administrator with a way to confirm deletion of an entire catalog, including all versions for the catalog. This screen is reached by selecting Delete Checked Catalogs from the Content Overview screen.

### Upload Content Screen

Selecting the Upload Content link will allow the Content Administrator to upload content (base data) for each supplier. Already existing, uploaded content on the server is also displayed for each supplier on this screen.
Select Supplier: Select the supplier for whom to upload content.
Content on Server: This is a list of files currently already uploaded for each supplier, including information on file name, size and date the file was last modified on the server.
Specify local data source: Enter the file path or click Browse to select the local file path and name location of the base catalog data to be uploaded.
Upload New Source: Click this to begin uploading the selected data for the selected supplier.

### Catalog Summary Screen

From the Content Overview Screen, clicking on a specific Catalog name brings up the Catalog Summary Screen. This screen provides specific catalog and catalog version information and functionality. On this screen Content Administrators can:
View Catalog Details (for the selected catalog)
View details of existing versions for catalog
For a Catalog:
   a. Set Catalog Access on and off
   b. Set Catalog Site (Buying Group) Visibility
   c. Set Catalog Sort Preference Level
Create New Version
For a specific catalog version:
   a. Review Items
   b. View Log
   c. Delete Version
   d. Approve Version
   e. Reject Version
   f. Activate Version
   g. Delete Version.
      These actions are described in more detail in the following sections.
      The Catalog Status section provides general information about the catalog:
Catalog ID: Displays the value of the catalog's identifier.
Supplier: Displays the name of the supplier associated to this Catalog.
Catalog Type: Displays the catalog format type: CIF, CSV, Internet Punchout, IntelleSpotBuy.
Catalog Access: Final User Search Access (visibility) to this catalog. Can be set to either On or Off.
Catalog Site Visibility: Displays which sites may see this catalog (when Catalog Access is turned On).
Catalog Sort Preference: The order in which the search results appear.

### Version Status—Details

The Version Status section displays the status of each available catalog version and offers actions based on the state of the catalog version. The Content Administrator can also delete a catalog version. Please note that multiple versions may exist for a catalog, but that there can be only one active version per catalog, and that there must be one active catalog version, in order to be able to turn Catalog Access On and thus make a catalog searchable to permissioned end users. The Version Status table contains the following information for each catalog version that exists in the system:
Select radio button: Select a radio button and then click one of the following links: Activate Selected Version, Approve Selected Version, Reject Selected Version, to change this version's approval or active status.
Active Status: Only one version per catalog can be in the Active state.
Version ID: A number representing the catalog version identifier.
Index Status: Displays the create/loading status value of the respective catalog version. Values include: ready, loading, and incomplete. Please see Create/Loading Section for more information.
Approval Status: Displays status as Approved, Pending and Rejected.
Item Count: Displays the number of catalog items loaded.
Page Count: Displays the number of pages loaded.
Date: Displays the date the version was loaded.
Review Items: The Content Administrator can view details of the loaded catalog items in each version by clicking on the review link (under Review Items) for the specific catalog version required.
View Log: A Content Administrator can view the last several hundred lines of the log file that summarizes activities for the creation of a specific catalog version. The View Log File screen displays the log file of the version creation process. The log file details can be useful to the Content Administrator for troubleshooting problems encountered in creating a catalog version.
Delete Checkbox: Check this box and then click on the Delete Checked Versions link to delete catalog version(s).

### Review Items Screen

From the Catalog Details screen, for a specific catalog version, when clicking Review, brings up the items of the selected catalog version. On this screen Content Administrators can view the items of the version and search within the items for specific terms.

### Create New Version Screen

To create a new version for an existing catalog, the Content Administrator must select the Create New Version option on the Catalog Summary Screen.
Clicking the Create New Version button invokes, depending on the catalog type, a straight-forward one to four-step process. For catalogs of type IntelleSpotBuy version creation is a one step process. For catalogs of type Internet Punchout and CIF version creation is a two step process. For catalogs of type CSV version creation is a straight-forward four step process. Step 1 of the process is used to specify the data source, i.e., the actual data file that will become the on-line catalog. Step 2 is used to select an optional web enhancement of the content. Step 3 is used to map the source data to the internal system data. Step 4 is used to apply content updates (for IntelleSpotBuy and Convert-as-you-Buy type catalogs).

### Create New Version—IntelleSpotBuy

When a new IntelleSpotBuy catalog is created, the first version of this catalog is automatically created, without prompting the Administrator User for further input. The first version created is an empty catalog version (meaning no items exist for this supplier's IntelleSpotBuy catalog yet).
Once end users start to create IntelleSpotBuy orders for a given supplier within IntelleCat, the Content Administrator User, if so configured, will be presented with the options displayed below when clicking Create New Version for an IntelleSpotBuy catalog.
This screen allows the Administrator User to apply content/item updates as provided by end users in order to purchase a SpotBuy/Free Text order. The Administrator User can choose to save this information as a cataloged item and thus make this item searchable. The Administrator User can also choose to delete this information prior to a specified date.

### Create New Version—Internet Punchout, CIF

Version creation for catalogs of type Internet Punchout or CIF is a two step process. Step 1 is used to specify the data source. Step 2 is used to select an optional web enhancement of the content. Note that due to the static field nature in files of type ‘CIF’ IntelleCat can automatically map existing file fields to IntelleCat System fields. Thus, the field mapping screen (Step 3) is not required.

### Create New Version Screen—Internet Punchout, CIF—Step 1

After selecting the “Create New Version” option, you are taken to this screen. From this screen you can:
Step 1—Content Source—Select a file from the drop down list to be used as the source of data for this catalog. The options that appear in the drop down are files that have been uploaded previously for this supplier via the Upload Content Screen.

### Create New Version Screen—Internet Punchout, CIF—Step 2

Step 2—Enhance with Web content—This section initially contains only one option—Enhance with Web content. If this option is not set or is set to “No”, this is all the information required for version creation. If the option is set to “Yes”, a series of further options is displayed. This option controls the details of the web enhancement process.
   When the Administrator User chooses to enhance a catalog (Enhance with Web Content set to Yes), the screen refreshes to display the following additional options:
   At most times the default selected values for the web enhancement options may remain selected.
   For the enhancement of Internet Punchout catalogs in most cases the recommended option is to use a configuration profile provided by us.
   For further details on the Web Catalog Enhancement Process please see the Web Catalog (Punchout) Enhancement section further below.

### Create New Version—CSV

### Create New Version Screen—CSV—Step 1

Step 1—Content Source—Select a file from the drop down list to be used as the source of data for this catalog. The options that appear in the drop down are files that have been uploaded previously for this supplier via the Upload Content Screen.
Step 1—Row Number of Column Headers—Enter the number of the row where column header names are specified. The rows are numbered starting from 1. The values found in this row are used to set names for the data columns found in the file. Specify ‘0’ to indicate that the file does not contain this information and the column names should be set to the number of each column in the file. Note: This option will only appear for generic record-based files (e.g., CSV). Field names are already specified in CIF and some other standard e-Commerce file types.
Step 1—Rows to Skip—Should IntelleCat skip the first few row(s) when indexing this data file as content, specify number of rows to skip here. In most cases this will be ‘0’ indicating that no rows should be skipped for indexing.

### Create New Version Screen—CSV—Step 2

Step 2—Enhance with Web content—This section initially contains only one option—Enhance with Web content. If this option is not set or is set to “No”, this is all the information required for version creation. If the option is set to “Yes”, a series of further options is displayed. This option controls the details of the web enhancement process.

### Create New Version Screen—CSV—Step 3

IntelleCat allows a field mapping for record-based catalogs, thus if necessary allowing content to be enabled which might have different column headers, fields for each catalog. The Content Administrator User maps on this screen the fields contained in the supplier's content data source to available IntelleCat System fields. This action for this catalog will be learnt and remembered by the system.
Please note that IntelleCat supports different Buyer Categories, such as UNSPSC and SPSC codes.

### Version Creation—Load Process

After the appropriate catalog version information is entered, click the Create Version button to start the version creation process. The amount of time that the loading process will take depends on variables such as the size and type of catalog, network configuration and load.
During this process the Catalog Summary screen can be refreshed. A Reload Page button appears, which replaces the Create New Version option. Periodically selecting this option as the catalog is loaded will provide status reports that will appear in the Version Status box.
While a version is loading, an additional option appears to the user on the Catalog Summary Screen which is an Abort Loading button. By clicking Abort Loading the version creation process will be interrupted and stopped.
When the load is complete the Version Creation Progress box will disappear and the Create New Version option will be available. The status will display as:
Ready—Displays if the catalog load was fully completed.
Incomplete—indicates that less than 100% of the data was loaded or enhanced. Note: The status should only display as incomplete for catalogs in which content is being web enhanced, e.g. for Internet Punchout type catalogs. An incomplete version is usually the result of a small number of pages on the supplier's web site being unavailable. An incomplete status does not indicate a failed load and in most cases it would be appropriate to make the version active. The catalog data that had been retrieved was successfully loaded.
Loading—Indicates the version is currently being created.
Aborting—Indicates the Administrator User requested to abort the creation of a version before it was complete, and the abort process is in process.
No Data—Indicates no data was loaded in in creating a new index, such as from attempting to create a catalog version from an invalid file type, or if for example the application is shut down while a catalog version load was in progress.

### Web Catalog (Punchout) Enhancement

Web catalog (punchout) sites are supplier eCommerce web sites that support a type of ‘punchout’ communications protocol, for example OCI or cXML. IntelleCat can communicate with web (punchout) sites in various ways, including via the OCI and the cXML protocols.

### Web Catalog Enhancement Configuration Requirements

We require a 30 business days notification from suppliers should their web punchout catalog site be changing.

Web catalog (punchout) sites are often customized according to the company punching out to the site. That is, the web catalog site can be configured to show items and pricing specific to a corporate organization. This section describes the configuration requirements to reflect such company-specific customization for an enhanced web catalog (punchout) index.
An enhanced web catalog (punchout) version/index is created by the IntelleCat Content Administrator.
User information used during the punchout setup request is that of a valid company user.

Should the web catalog site supplier maintain different content per ‘Site’ (Buying Group) or different content per Locale (user language) the web catalog version creation should be performed as a user who has the correct Site and Language information assigned to them so this supplier-site specific information will be reflected in the enhanced web catalog index.

### Web Catalog (Punchout) Enhancement Process

The prerequisite for creating an enhanced web (punchout) catalog is that a relationship between the Buyer and the Web Catalog Supplier has been created and that basic (“plain”) punchout connectivity has been successfully established between the Buyer and the Web Catalog Supplier.
Some of the steps required for the Buyer and the Web Catalog Supplier as part of the prerequisite process may include the following:
1. The Buyer and their selected Supplier work out a business relationship, which typically includes for example contracts, custom item list, pricing.
2. The Buyer and the Supplier establish how, for example which protocol shall be used, for the basic punchout connectivity. For example, this could be via the OCI protocol or via the cXML protocol.
3. The Buyer will confirm that they have successfully established basic punchout connectivity to the Web Catalog Suppliers' test and production web sites, and that the Buyer is being logged in correctly, and thus able to see the correct view of the web catalog site (including custom item visibility and pricing).
4. Buyer provides punchout site access information to Engineering. This information can vary depending on the type of punchout connectivity used.
5. The Buyer, the Web Catalog Supplier and us arrange to have a conference call to go over general questions either the Web Catalog Supplier or us might have in regards to the enhanced web catalog punchout process or the web catalog site. As a Web Catalog Supplier plans for changes to their web catalog site (for example: addition of new features, or a change to a new site) it is required that the Web Catalog Supplier notifies the Buyer and us of such changes 30 business days in advance.
6. We configure a Web Catalog Supplier profile and makes this available to the Buyer.
7. Buyer creates a new enhanced web catalog version for the selected Web Catalog Supplier.

### Creation and Maintenance of Supplier Data

### Create New Supplier Screen

From the IntelleCat Administrator Navigation bar clicking on the Create New Supplier link will take you to this screen. From this screen the correctly permissioned IntelleCat Administrator user can create new suppliers by entering the following required and optional information:
Supplier Name (required)
Supplier ID (required)
Supplier Contact Name
Supplier Contact Email
Supplier Contact Phone
Supplier Contact City
Supplier Contact Country
   Clicking on the Create Supplier button creates this supplier in IntelleCat and takes the user to the View Suppliers Screen.

### View Suppliers Screen

From the IntelleCat Administrator Navigation bar clicking on the View Suppliers link will take you to this screen. From this screen the correctly permissioned IntelleCat Administrator user can view all suppliers available in the IntelleCat system. The following information is displayed for each supplier, where valid values exist:
Delete Checkbox
Supplier Name
Supplier ID
Contact Name
Contact Email
Contact Phone
Contact City
Contact Country
   From this screen a correctly permissioned IntelleCat Administrator User can also perform the following actions:
Delete Checked Suppliers
This function allows the User to delete existing suppliers from IntelleCat, by clicking on the checkboxes for the desired supplier(s) and then clicking on the Delete Checked Suppliers link.
Edit Existing Supplier Information
By clicking on a Supplier Name the User is taken to the Edit Suppliers Screen from where information about this supplier can be edited.

### Creation and Maintenance of IntelleCat Administrator User Data

### Create New Administrator User Screen

From the IntelleCat Administrator Navigation bar clicking on the Create New User link will take you to this screen. From this screen the correctly permissioned IntelleCat Administrator user can create new IntelleCat Administrator users by entering the following required and optional information:
User Login Name (required)
User Login Password (required)
User First Name
User Last Name
User Locale
User Permissions (required)
Permissioned Suppliers (required)
   When creating a new Administrator User the selected User Permissions will be available to the new User for the selected Permissioned Suppliers only.
   Clicking on the Create User button creates this new Administrator User in IntelleCat and takes the user to the View Administrator Users Screen.

### View Administrator Users Screen

From the IntelleCat Administrator Navigation bar clicking on the View Users link will take you to this screen. From this screen the correctly permissioned IntelleCat Administrator User can view all Administrator Users available in the IntelleCat system. The following information is displayed for each Administrator User, where valid values exist:
Delete Checkbox
Login Name
Login Password (hidden)
First Name
Last Name
Locale
Permissions
Permissioned Suppliers
   From this screen a correctly permissioned IntelleCat Administrator User can also perform the following actions:
Delete Checked Users
This function allows the User to delete existing Administrator Users from IntelleCat, by clicking on the checkboxes for the desired User(s) and then clicking on the Delete Checked Users link.
Edit Existing User Information
By clicking on a User's Login Name the Administrator User is taken to the Edit Administrator User Screen from where information about the selected User can be edited.

### Price Audit Overview Screen

An overview of all catalogs available in the system. The following information is displayed for each catalog in the system:

### Catalog Name

Acts as a link to the Price Audit Summary Screen for the one catalog.

### Latest Audit Created On (Date)

The creation date of the most recent Price Audit created for this catalog is displayed in this field.
   Clicking on any catalog name will take you to the Price Audit Summary Screen for that particular catalog.

### Price Audit Summary Screen

The Price Audit Summary Screen provides information and functionality for each Price Audit which has already been created for this catalog. On this screen you can:
Create a New Price Audit
Delete a Price Audit
Go to the Details Screen of a Price Audit

### Create

Clicking on the ‘Create’ button on top of this screen will take you to the Create New Price Audit screen for this catalog.

### Summary Table of Existing Price Audits

The summary table of all existing Price Audits for this catalog displays the following information for each Price Audit:

### Existing Audit

Display name of existing Audit for this catalog. Display name naming convention of Audits are as follows:
“Audit_V<baseVersionID>_diff_V<compareVersionlD>. The name acts as a link to the Price Audit Detail Screen for this Audit.

### Compares Version (ID and Date)

The version ID number of the Base Version used for this Audit plus the creation date of this VERSION is displayed in this field.

### To Version (ID and Date)

The version ID number of the Compare To Version used for this Audit plus the creation date of this VERSION is displayed in this field.

### Audit Created (Date)

The creation date of this Price Audit is displayed in this field.

### Status (Creating/Success)

Displays the status of this Price Audit.

### Delete

Clicking the delete link will delete this Price Audit.

### Create New Price Audit Screen

After clicking on the Create button on the Price Audit Summary Screen, the Create New Price Audit Screen is displayed. Here you can:
Create a Price Audit comparing any two eligible and existing versions of this catalog with below detailed options. Any Price Audit created will automatically be created in two formats: CSV format (viewable with your spreadsheet software) and HTML format (viewable right in your browser).
Go back to Price Audit Summary Screen without creating a new Price Audit.

### Compare Base Version

If eligible versions already exist for this catalog their ID number, creation date, and Index Entry count will be displayed in this dropdown. Eligible versions are any existing versions for static catalogs, and ENHANCED versions for web (punchout) catalogs. Unenhanced web (punchout) catalog versions typically contain only 1 item with no price, and thus a Price Audit would not make sense to be created. If no eligible versions are available for the particular catalog a Price Audit cannot be created for this catalog, and this dropdown will only display ‘no valid versions’.

### To Version

If eligible versions already exist for this catalog their ID number, creation date, and Index Entry count will be displayed in this dropdown. Eligible versions are any existing versions for static catalogs, and ENHANCED versions for web (punchout) catalogs. Unenhanced web (punchout) catalog versions typically contain only 1 item with no price, and thus a Price Audit would not make sense to be created. If no eligible versions are available for the particular catalog a Price Audit cannot be created for this catalog, and this dropdown will only display ‘no valid versions’
A different version should be selected in this dropdown than was selected in the Base Version dropdown.

### Create for Minimum Price Change of

Defaults to value “0.5”%. Any items with a price change, increase or decrease, of this percentage or higher will be included in the Price Audit. This field can be set to any positive numeric value from 0-100. The value of “0”% indicates to IntelleCat that all items should be included in the Price Audit.

### Include Detailed Item Description

Selecting ‘Yes’ from this dropdown will include the enhanced description, typically available for all enhanced punchout items, in the Price Audit. This is the detailed item description as usually displayed in the IntelleCat Search Results.
Selecting ‘No’ from this dropdown will not include the enhanced description, typically available for all enhanced web catalog items, in the Price Audit. Only the title or short name of the item will be included in the Price Audit.

### Price Audit Details Screen

Clicking on any existing Price Audit's name from the Price Audit Summary Screen will take you to the Price Audit Details Screen for the chosen Price Audit. From this screen you can:
Download a copy of the Price Audit in CSV format—viewable with your spreadsheet software.
Download a copy of the Price Audit in HTML format—viewable right in your browser.
Review the details of this Price Audit as outlined below.
Go back to Price Audit Summary Screen.

### Price Audit Details

The following details are displayed for your chosen Price Audit on this screen:

### Audit Name

This name represents the actual file name as it exists in your filesystem for this Audit. Naming convention for this actual file name is as follows: “<CatalogName>-v<baseVersionID>-diff-v<compareVersionID>.csv”

### Compares Version (ID, Date, Index Entry Count)

The version ID number, creation date of the version plus the version's index entry count for the Base Version is displayed in this field.

### To Version (ID, Date, Index Entry Count)

The version ID number, creation date of the version plus the version's index entry count for the Compare To Version is displayed in this field.

### Minimum Price Change

The minimum price change percentage which was selected at time of creation of this Audit. Any items with a price change, increase or decrease, of this percentage or higher are included in the Price Audit. The value of “0%” indicates that all items are included in the Price Audit.

### Includes Detailed Item Description

Displays the value which was chosen for this field at the time of Price Audit creation. ‘Yes’ indicates that the enhanced description, typically available for all enhanced punchout items, are included in this Price Audit. This is the detailed item description as usually displayed in the IntelleCat Search Results. ‘No’ indicates that the enhanced description is not included in this Price Audit. Only the title or short name of the item is included.

### Price Audit Summary Details

The following Summary details are also displayed for your chosen Price Audit on this screen. These Summary details are also included in the downloadable CSV or HTML Price Audit:
   Items with Price Increase
Number of items in this Price Audit which had a price increase in the Base Version as compared to the Compare To Version.
   Items with Price Decrease
Number of items in this Price Audit which had a price decrease in the Base Version as compared to the Compare To Version.

### Highest % Price Increase

Percentage of the highest price increase in this Price Audit as compared to the Compare To Version.

### Highest % Price Decrease

Percentage of the highest price decrease in this Price Audit as compared to the Compare To Version.

### New Items

Number of items in this Price Audit which are new items in the Base Version as compared to the Compare To Version.

### Deleted Items

Number of items in this Price Audit which are deleted items in the Base Version as compared to the Compare To Version.

### IntelleCat Field Appendix

### IntelleCat System Field Names

Currency
Image URL
Item Category
Item Category Type
Item Description
Item Short Name
Language
Lead Time
Manufacturer Name
Manufacturer Part ID
Manufacturer URL
Market Price
Supplier ID
Supplier Part ID
Supplier URL
Unit of Measure
Unit Price
Attribute 1
Attribute 2
Attribute 3
Attribute 4
Attribute 5

### IntelleCat Catalog Administration and Maintenance

IntelleCat Catalog Administration and Maintenance makes it possible for you to get your catalogs online with a few simple steps. IntelleCat has optional features such as enhancing basic punchout entries and CIF catalogs to include descriptive item information to enhance the shopping experience and increase the probability of purchase. These tasks are accomplished utilizing a unique patent-pending technology.

### Catalog Administrator's Manual

This manual focuses on the catalog administration and maintenance aspects of the IntelleCat application. It will explain and illustrate the features and functionality of IntelleCat catalog administration.

### Catalog Access Setup

### Partitions

An Ariba administrator will have already determined which suppliers are visible to which partitions. IntelleCat will use this information automatically, when partitions are created and maintained with the Ariba Buyer Administrator interfaces. For example, a user in partition A who is searching for items using IntelleSearch, will only be shown items which are found in the catalogs of those suppliers who are visible to partition A.
Please Note: IntelleCat administers catalogs rather than suppliers. Since most catalogs contain items from a single supplier, managing by catalog is very similar to managing by supplier. IntelleCat does not currently support a single catalog which contains items from many suppliers. IntelleCat does support a single supplier having more than one catalog. IntelleCat supports one language in a catalog.

### Filters

Ariba Buyer partition structures provide the basic data for content filtering, as described above. In some scenarios, a more detailed and customizable filter is required for more precise search results. IntelleCat supports a mechanism (IntelleCat Content Filter) to implement a customized catalog filter via Java.
Note: IntelleCat Content Filters can use the Partition, User and Requisition Ariba objects in Java to implement the desired filtering logic.
Note: IntelleCat Content Filters provide functionality comparable to the custom catalog views supported by Ariba Buyer. However, because the architecture of IntelleCat is different from Buyer, the exact form of IntelleCat Content Filtering is different from the Buyer custom catalog views, while implementing similar functionality.
   IntelleCat Content Filters contain two interdependent components: Catalog Index Filter Component and Search Filter Component. The Catalog Index Filter Component is invoked during IntelleCat's indexing of catalog content and is used to pre-compute data fields used by the Search Filter Component. This pre-computation approach aids in optimizing the run-time performance of the Search Filter Component. The Search Filter Component is invoked upon user search.
IntelleCat Content Filters are typically implemented at the customer's site by the customer's technical personnel. However, we can provide pre-built IntelleCat Content Filters for certain ERPs.

### Catalog Administration

### Loading Catalogs

The process for loading Ariba-hosted catalogs into IntelleCat is simple and straightforward, whether the catalog is being loaded for the first time or re-loaded subsequent to a catalog update.
After logging in to Ariba Buyer, click on the Catalogs link in the “IntelleCat Admin” section from the Ariba menu on the left side of the Ariba Buyer screen. This will bring up the Catalog Maintenance Screen.
Please Note: The user must have the necessary permissioning in order to access the catalog administration and maintenance section of IntelleCat.
To view the IntelleCat Admin section a user has to be an Ariba Administrator.
To view the IntelleCat Catalog Admin link within this section a user has to have the additional following permission set:
The permission for the IntelleCat Catalog Admin link is set in Ariba's Parameters.table configuration file with the parameter
“IntelleCat. CatalogAdminPermission”. By default this permission is set to the “CatalogManager” permission.

### Catalog Maintenance Screen

An overview of the status of all catalogs that have been loaded through Ariba into your system will be displayed.

### The Catalog Data Display Contains the Following Information:

Link to new catalog data
When the “Synchronize with Ariba database for new supplier and catalog setup” link is clicked the Catalog Maintenance Screen is synchronized with parts of the Ariba Buyer Administrator. Subsequently, the screen is updated with:
   New catalogs that have been loaded into Ariba (i.e.: this includes any new Contract Subscriptions).
   Old catalogs that are no longer available are removed (e.g.: inactive Ariba catalogs, expired Contract Subscriptions).
Note: It is mandatory to click this link after catalog permissions or partitions are changed in Ariba, or when adding new variants, partitions or other AML-related schema changes.

### Catalog Name

Acts as a link to the Catalog Summary Screen

### Catalog User Access (On/Off)

Displays the status of user access for each catalog.
Please Note: The items in this catalog must belong to a single supplier. The partition the user has logged into must support access to this supplier for this catalog to be visible to the user.

### Catalog Sort Preference

Acts as a link to the Set Supplier/Catalog Sort Preference page.
Link shows a number between 1 and 20, or “No Preference” to indicate the sorting preference.

### Active Version Enhanced (Yes/No)

If enhanced catalog data has been loaded for the active version of this particular catalog, this field will display “Yes”.

### Latest Version Active (Yes/No)

If new catalog versions have been loaded, but the most recently created version is currently not selected as the active version, this field will display “No”.

### Latest Version Loaded On (Date)

The creation date of the most recent catalog version is displayed in this field.

### Latest Version Status (Ready/Incomplete/Loading)

Displays the status of the latest catalog version.
   Clicking on any catalog name will take you to the Catalog Summary screen for that particular catalog.

### Catalog Summary Screen

The Catalog Summary screen provides specific catalog information and functionality. On this screen you can:

| | | | |
|---|---|---|---|
| ✓ | Change User Access | ✓ | Create a New Catalog Version |
| ✓ | Make a Catalog Version Active | ✓ | Delete A Catalog Version |
| ✓ | View Enhancement Details or | ✓ | Abort A Version Creation, |
| | Log Files | | during load |

On the left side of the IntelleCat window you will see a complete list of all available IntelleCat catalogs. There is also a link above the table—“Back to Overview”—that will take you back to the Overview screen. Clicking on any catalog name will take you to the Catalog Summary page for that particular catalog. This list is available on most screens in the IntelleCat Catalog Administration section.
On the Catalog Summary page there are three sections to PriceAudit you to administer catalogs. They are:
1. Catalog Status
2. Version Status
3. Version Maintenance

### Catalog Status

In the Catalog Status section you can administer User Access. If you want the catalog to be made available for searching by IntelleCat users, simply turn User Access to “On” by clicking the toggle button “Change User Access to On.” If User Access is already enabled you can take a catalog offline—without deleting it—by clicking the toggle button “Change User Access to Off.”
Please Note: A new version that is selected to be active in the Version Maintenance section will immediately become searchable when catalog user access is ‘On’.
Please Note: This button will not appear if a catalog version has not yet been created or if a version has not yet been made active.
   The Catalog Status section will also let you know the catalog type: Non-Punchout or Punchout.

### Catalog Sort Preference

Sets the sort order within a result set for this catalog. If set to “1”, search results from this catalog will be at the top of your search results. The maximum setting is “20”. If there is no need to sort search results from a catalog in a particular order relative to other catalogs, the Sort Preference for this catalog can be set to “No Preference”.
For ease of management, multiple catalogs can be set to the same preference level, e.g., all inventory catalogs set to “1”, to always appear first in the result set.
The default setting for a new catalog is “No Preference”. When some catalogs have been given a numeric setting, the catalogs with the “No Preference” setting will be sorted to the end of the result set, after catalogs with any numeric setting.

### Version Status

In the Version Status section you can create a new catalog version by clicking on the “Create New Version” button. The Create New Catalog Version screen will then appear and you can select your catalog loading parameters. The most recent catalog data can be loaded via that screen and made available for searching. The Create New Catalog Version screen is explained in greater detail below.
The Version Status section will also display:
Active Catalog Version ID number
Latest Catalog Version ID number
Latest Catalog Version Status (Ready/Incomplete/Loading)

### Version Maintenance

The Version Maintenance section allows you to select which version of a catalog to make active (searchable). In order to make a particular catalog version active, simply select the radio button for the version you want to make active and then click the “Make Selected Version Active” button. In order to delete a catalog version, simply click on the “delete” link to the left of the particular version.
Please Note: A version cannot be deleted if it is active.
   You can also view specific details about Catalog Enhancement (discussed below) and view log files that are created when the specific catalog version is created by clicking the respective links in the Enhancement Details or the Log File columns.
   It is recommended that no more than two versions of any one catalog be retained at the same time. Therefore, when a new version is being made active, if older versions exist, you will be taken to the Version Maintenance screen.
   On the Version Maintenance screen there is a reminder that asks if you would like to delete the oldest catalog version with two buttons—“Yes, delete” and “No, do not delete”. After making your selection you will be taken back to the Catalog Summary screen, regardless of which you choose and the selected version will be made active. The version number, creation date and catalog name are also displayed on the Version Maintenance screen
Please Note: You can still delete catalog versions with the delete link, described above, in the Version Maintenance section of the Catalog Summary screen.
Please Note: We recommend retaining one inactive version of a particular catalog as a backup.

### Create New Catalog Version Screen

After clicking on the “Create New Version” button, the Create New Catalog Version screen is displayed. Here you can:
Create a new version of the catalog
Choose to enhance content (Optional Feature)
Set new server options—or select default settings—when enhancing content (Optional Feature)
Choose to auto-create a Price Audit Diff, at the end of version creation, comparing an old version of this catalog (if existent) to this new version about to be created (Optional Feature)
Start the new version creation process
   On the left side of the IntelleCat window you will see the list of available catalogs and a link above the table that will take you back to the Overview screen. Clicking on any catalog name will take you to the Catalog Summary page for that particular catalog.
   On the Create New Catalog Version screen there are three optional features available to PriceAudit you to administer your catalogs. They are:
1. Choose to Enhance Catalog Content (Optional Feature)
2. Content Enhancement—Server Options (Optional Feature)
3. Choose to Create Price Audit (Optional Feature)
   On non-punchout catalogs you can select to enhance content from the Supplier or from the Manufacturer or from both (as an Optional Feature). Enhanced content can provide the shopper with a greater amount of item detail. This will facilitate the process and enable a more accurate selection of a particular item(s).
   Enhancement Option Non-Punchout

### Server Options (Optional Feature)

There are six (6) server options for Content Enhancement (for both Non-Punchout and Punchout catalogs)
1. Enhancement Scope
2. Enhancement Depth
3. Maximum Threads
4. Timeout Requests
5. Extensive Logging
6. URL Control.
Please Note: Before setting the Server Options outlined below, please contact Engineering in order to determine the optimum settings for your environment.

### Enhancement Scope (Optional Feature)

In the Enhancement Scope section there are three alternatives:
1. Limited: this option includes all links on the Web that remain under the same URL path.
   This option will more closely control your extraction path.
2. Extended: this option includes all links on the Web that stay on the same server.
   This option will enable data extraction from a larger portion of the site.
3. Unlimited: this option includes all links on the Web.
   This option will explore all links associated with a particular site, even if they are links to another server.

### Enhancement Depth (Optional Feature)

Specifies how many levels from the URL that the extraction will extend to. Selecting the default of 5 will extract a reasonable amount of data.

### Max Threads (Optional Feature)

Specifies the maximum number of concurrent threads to use in the enhancement process. The default setting is 5.

### Timeout Requests (Optional Feature)

Specifies the amount of time that will be allowed to elapse before a request is aborted. The default value of sixty (60) seconds is recommended for most sites.

### Extensive Logging (Optional Feature)

Specifies the amount of logging to be saved in the catalog loading log file, which can be accessed on the Catalog Summary screen.
Please Note: Selecting “Yes” for this option should only be used for troubleshooting. Enabling this feature can create extremely large log files in a production environment.

### URL Control (Optional Feature)

The administrator has the option to set the Server Options described above and also to enter information into the URL Control area (below). If this method is utilized, then the Administrator should also set the Enhancement Scope and Enhancement Depth fields as well.
By selecting yes and entering the URLs that you wish to be accessed in the text box, you can effectively control the exact URLs that will be eligible for data extraction. Utilizing the syntax characters “*”, “?” can limit the extent to which additional pages will be made available in the extraction process.
For example:
   If you enter “http://www.company.com/productsjsp*”, the “*” character enables the extraction to extend itself to this URL path and the path plus any number of additional characters.
If you enter “http://www.company.com/productsjsp?”, the “?” character enables the extraction to extend itself to this URL path and the path plus one additional character.
   Enhancement Option Punchout
   Punchout catalogs have only one option in the Choose to Enhance Catalog Content section: Yes or No.
   When enhancing a punchout catalog (Optional Feature), there are several server options available. The easiest and most highly recommended option is to use a profile file provided for each punchout catalog that is used. A profile file is defined and tailored specifically for each punchout site for optimal enhancement results.

### Option: Price Audit (Optional Feature)

Choose to auto-create a Price Audit Diff, at the end of version creation, comparing an old version of this catalog (if existent) to this new version about to be created. Any Price Audit created will automatically be created in two formats: CVS format (viewable with your spreadsheet software) and HTML format (viewable right in your browser).

### Create Price Audit (Optional Feature)

Selecting ‘Yes’ from this dropdown will create a Price Audit Diff at the end of version creation with options defined in below section.
Selecting ‘No’ from this dropdown will not create a Price Audit Diff at the end of version creation. Below options do not take effect.

### Compare to Version (Optional Feature)

If other eligible versions already exist for this catalog their ID number will be displayed in this dropdown. Eligible versions are any existing versions for local, non-punchout catalogs, and are ONLY ENHANCED versions for punchout catalogs. Unenhanced punchout catalog versions typically contain only 1 item with no price, and thus a Price Diff cannot be created for unenhanced punchout catalog versions. To create a valid enhanced punchout version please contact your representative. If no eligible versions are available for the particular catalog a Price Audit Diff cannot be created, and this dropdown will only display ‘no valid versions’.

### Create for Minimum Price Change of (Optional Feature)

Defaults to value “0.5”%. Any items with a price change, increase or decrease, of this percentage or higher will be included in the Price Audit. This field can be set to any positive numeric value from 0-100. The value of “0”% indicates to IntelleCat that all items should be included in the Price Audit.

### Include Detailed Item Description (Optional Feature)

Selecting ‘Yes’ from this dropdown will include the enhanced description, typically available for all enhanced punchout items, in the Price Audit. This is the detailed item description as usually displayed in the IntelleCat Search Results.
Selecting ‘No’ from this dropdown will not include the enhanced description, typically available for all enhanced punchout items, in the Price Audit. Only the title or short name of the item will be included in the Price Audit.

### Version Loading

After you decide whether to enhance content and select your enhancement options, if applicable (Optional Feature), and whether to auto-create a Price Audit for this version, if applicable (Optional Feature), clicking on the Create button will start the version creation process. The amount of time that the loading process will take varies depending on variables such as the size and type of catalog; network configuration and load; etc.
During this process the Catalog Summary screen will reappear, but it will differ slightly. A Refresh Page button near the top of the screen, will replace the Create New Version button. Periodically clicking this button as the catalog is loaded will provide status reports that will appear in the Version Status box.
There is also one additional box, the Version Creation Progress box that will display the elapsed time of the load, the average loading rate and an Abort Loading button.

### Price Audit (Optional Feature)

From the Ariba Buyer Home page, click on the Price Audit link in the “IntelleCat Admin” section, from the Ariba menu on the left side of the Ariba Buyer screen. This will bring up the Price Audit Overview Screen.
Please Note: The user must have the necessary permissioning in order to access the IntelleCat Admin section. To view the IntelleCat Admin section a user has to be an Ariba Administrator.
Please Note: This feature needs to be configured ‘on’ in order for this link to appear under the IntelleCat Admin section.

### Price Audit Overview Screen

An overview of all catalogs available in the system. The following information is displayed for each catalog in the system:

### Catalog Name

Acts as a-link to the Price Audit Summary Screen for the one catalog. Latest Audit Created On (Date)
The creation date of the most recent Price Audit created for this catalog is displayed in this field.
   Clicking on any catalog name will take you to the Price Audit Summary Screen for that particular catalog.

### Price Audit Summary Screen

The Price Audit Summary Screen provides information and functionality for each Price Audit which has already been created for this catalog. On this screen you can:

| | | | |
|---|---|---|---|
| ✓ | Create a New Price Audit | ✓ | Go to the Details Screen of a Price |
| ✓ | Delete a Price Audit | | Audit |

On the left side of the IntelleCat window you will see a complete list of all available IntelleCat catalogs. There is also a link above the table—“Back to Overview”—that will take you back to the Overview screen. Clicking on any catalog name will take you to the Price Audit Summary Screen for that particular catalog. This list is available on most screens of the IntelleCat Price Audit Administration section.

### Create

Clicking on the ‘Create’ button on top of this screen will take you to the “Create New Price Audit” screen for this catalog.

### Summary Table of Existing Price Audits

The summary table of all existing Price Audits for this catalog displays the following information for each Price Audit:

### Existing Audit

Display name of existing Audit for this catalog. Display name naming convention of Audits are as follows:
“Audit_V<baseVersionID>_diff_V<compareVersionID>. The name acts as a link to the Price Audit Detail Screen for this Audit.

### Compares Version (ID and Date)

The version ID number of the Base Version used for this Audit plus the creation date of this VERSION is displayed in this field.

### To Version (ID and Date)

The version ID number of the Compare To Version used for this Audit plus the creation date of this VERSION is displayed in this field.

### Audit Created (Date)

The creation date of this Price Audit is displayed in this field. Status (Creating/Success)
Displays the status of this Price Audit.

### Delete

Clicking the delete link will delete this Price Audit.

### Create New Price Audit Screen

After clicking on the “Create” button on the Price Audit Summary Screen, the Create New Price Audit Screen is displayed. Here you can:
Create a Price Audit Diff comparing any two eligible and existing versions of this catalog with below detailed options. Any Price Audit created will automatically be created in two formats: CVS format (viewable with your spreadsheet software) and HTML format (viewable right in your browser).
A Go back to Price Audit Summary Screen without creating a new Price Audit.

### Compare Base Version

If eligible versions already exist for this catalog their ID number, creation date, and Index Entry count will be displayed in this dropdown. Eligible versions are any existing versions for local, non-punchout catalogs, and are ONLY ENHANCED versions for punchout catalogs. Unenhanced punchout catalog versions typically contain only 1 item with no price, and thus a Price Diff cannot be created for unenhanced punchout catalog versions. To create a valid enhanced punchout version please contact your representative. If no eligible versions are available for the particular catalog a Price Audit Diff cannot be created, and this dropdown will only display ‘no valid versions’.

### To Version

If eligible versions already exist for this catalog their ID number, creation date, and Index Entry count will be displayed in this dropdown. Eligible versions are any existing versions for local, non-punchout catalogs, and are ONLY ENHANCED versions for punchout catalogs. Unenhanced punchout catalog versions typically contain only 1 item with no price, and thus a Price Diff cannot be created for unenhanced punchout catalog versions. To create a valid enhanced punchout version please contact your representative. If no eligible versions are available for the particular catalog a Price Audit Diff cannot be created, and this dropdown will only display ‘no valid versions’.
A different version should be selected in this dropdown than was selected in the Base Version dropdown.

### Create for Minimum Price Change of

Defaults to value “0.5”%. Any items with a price change, increase or decrease, of this percentage or higher will be included in the Price Audit. This field can be set to any positive numeric value from 0-100. The value of “0”% indicates to IntelleCat that all items should be included in the Price Audit.

### Include Detailed Item Description

Selecting ‘Yes’ from this dropdown will include the enhanced description, typically available for all enhanced punchout items, in the Price Audit. This is the detailed item description as usually displayed in the IntelleCat Search Results.
Selecting ‘No’ from this dropdown will not include the enhanced description, typically available for all enhanced punchout items, in the Price Audit. Only the title or short name of the item will be included in the Price Audit.

### Price Audit Details Screen

Clicking on any existing Price Audit's name from the Price Audit Summary Screen will take you to the Price Audit Details Screen for the chosen Price Audit. From this screen you can:
Download a copy of the Price Audit in CSV format—viewable with your spreadsheet software.
Download a copy of the Price Audit in HTML format—viewable right in your browser.
Review the details of this Price Audit as outlined below.
Go back to Price Audit Summary Screen.

### Price Audit Details

The following details are displayed for your chosen Price Audit on this screen:

### Audit Name

This name represents the actual file name as it exists in your filesystem for this Audit. Naming convention for this actual file name is as follows: “<CatalogName>-v<baseVersionID>-diff-v<compareVersionID>.csv”

### Compares Version (ID, Date, Index Entry Count)

The version ID number, creation date of the version plus the version's index entry count for the Base Version is displayed in this field.

### To Version (ID, Date, Index Entry Count)

The version ID number, creation date of the version plus the version's index entry count for the Compare To Version is displayed in this field.

### Minimum Price Change

The minimum price change percentage which was selected at time of creation of this Audit. Any items with a price change, increase or decrease, of this percentage or higher are included in the Price Audit. The value of “0%” indicates that all items are included in the Price Audit.

### Includes Detailed Item Description

Displays the value which was chosen for this field at the time of Price Audit creation. ‘Yes’ indicates that the enhanced description, typically available for all enhanced punchout items, are included in this Price Audit. This is the detailed item description as usually displayed in the IntelleCat Search Results. ‘No’ indicates that the enhanced description is not included in this Price Audit. Only the title or short name of the item is included.

### Price Audit Summary Details

The following Summary details are also displayed for your chosen Price Audit on this screen. These Summary details are also included in the downloadable CSV or HTML Price Audit:
   Items with Price Increase
Number of items in this Price Audit which had a price increase in the Base Version as compared to the Compare To Version.
   Items with Price Decrease
Number of items in this Price Audit which had a price decrease in the Base Version as compared to the Compare To Version.

### Highest % Price Increase

Percentage of the highest price increase in this Price Audit as compared to the Compare To Version.

### Highest % Price Decrease

Percentage of the highest price decrease in this Price Audit as compared to the Compare To Version.

### New Items

Number of items in this Price Audit which are new items in the Base Version as compared to the Compare To Version.

### Deleted Items

Number of items in this Price Audit which are deleted items in the Base Version as compared to the Compare To Version.
   1.1.1.1
   1.1.1.2

### 1.1.1.3 Section C

### 2. PriceAudit Screen Captures

2.1.1.1

### IntelleCat Price Audit for Punchout and Local Catalogs

### Screen Capture

Price Audit Detail: UK PunchOut Catalog

Screen Capture 1: Price Audit. One of the most unique features of IntelleCat is Price Audit for ALL types of catalog content. In this example, a Price Audit was automatically generated for an Internet Punchout catalog, calculating price movement and item movement for one of the Buyer's Internet vendor's site over a period of approximately one month.
Screen Capture 2: Price Audit. A Price Audit was automatically generated for an Internet Punchout catalog, calculating price movement and item movement for one of the Buyer's Internet vendor's site over a period of approximately three months.

What is claimed is:

1. A software method for extracting and capturing real-time price information from punchout suppliers, and comparing it to previous and negotiated prices.

2. A computer system comprising:
a first storage device for storing a plurality of previously submitted find-trees;
a processor connected to the first storage device, with the processor configured for:
enabling the extracting and capturing real-time price information from punchout suppliers, and comparing it to previous and negotiated prices.
